(19) United States
(12) Patent Application Publication
(10) Pub. No.: US 2019/0128709 A1
(43) Pub. Date: May 2, 2019

(54) Methods of Calculating Potential Energy in Substances and Light, Method of Creating Timeless Condition, and Methods of Creating Reverse Time

(71) Applicant: Motoko Hazama, Ashiya (JP)

(72) Inventor: Motoko Hazama, Ashiya (JP)

(21) Appl. No.: 15/732,335

(22) Filed: Oct. 27, 2017

(51) Int. Cl. G01D 21/00

(52) U.S. Cl. CPC G01D 21/00

(57) ABSTRACT

The method of calculating potential energy in substances as can be seen in the formula below in [Math.1]. E as is defined here is the potential energy in a substance, T is time the substance passes under no gravity, m₁ is mass (at its initial value), c₁ is velocity of light (at its initial value), and Tk is time the substance has passed under no gravity.

$$E = {\sum }_{K = 1}^{T} {m}_{1} {{c}_{1} ( 1 - {T}_{K} / T )}^{2} ( 1 ≦ K ≦ T ) \qquad [ Math . 1 ]$$

Further, the method of calculating potential energy in light as can be seen in the formula below in [Math.2]. E as is defined here is the potential energy in a substance, T is time the light passes under no gravity, m₁ is mass (at its initial value), c₁ is velocity of light (at its initial value), and Tk is time the light has passed under no gravity.

$$E = {\sum }_{K = 1}^{T} {c}_{1} ( 1 - {T}_{K} / T ) ( 1 ≦ K ≦ T ) \qquad [ Math . 2 ]$$

In addition, the formula below in [Math.3 ] sets up as derived from [Math.1] and [Math.2]. E as is defined here is the potential energy in a substance or light, m₁ is mass (at its initial value), c₁ is velocity of light (at its initial value), Tk is time the substance or light has passed under no gravity, and T is time the substance or light passes under no gravity, namely, the existence of time itself.

$$When E = {\sum }_{K = 1}^{T} {m}_{1} {c}_{1} {( 1 - {T}_{K} / T )}^{2} ( 1 ≦ K ≦ T ) and \\ E = {\sum }_{K = 1}^{T} {c}_{1} ( 1 - {T}_{K} / T ) ( 1 ≦ K ≦ T ) , \\ and when {m}_{1} = {c}_{1} = 0 , then E = 0 and T = Tk = ∞ . \qquad [ Math .3 ]$$

Moreover, the method of creating reverse time for substances as can be seen in the formula below in [Math.4]. E as is defined here is the potential energy in a substance, T is time the light passes under no gravity, m₁ is mass (at its initial value), c₁ is velocity of light (at its initial value), and Tk is time the light has passed under no gravity.

When

\sqrt{E/Σ_{K=1}^{T}m₁c₁}−1>0(1≤K≤T),T_{K}<0 [Math.4]

And lastly, the method of creating reverse time for light as can be seen in the formula below in [Math.5]. E as is defined here is the potential energy in a substance, T is time the light passes under no gravity, m₁ is mass (at its initial value), c₁ is velocity of light (at its initial value), and Tk is time the light has passed under no gravity.

When

E>Σ_{K=1}^{T}C₁(1≤K≤T), then T_{K}<0 [Math. 5]

### TECHNICAL FIELD

Physics

### BACKGROUND ART

Firstly, the concept of time is to be explained. On considering time, the dial of a clock is cited as a model. (cf. [FIG. 1]) A clock has a shaft in its center and numbers to indicate time on its circumference. It is conceivable that when shown in two-dimension, time is verily like the dial of a clock. That is, the shaft part doesn't turn and is in a state of a dot where there are no past, present nor future, or all those three compressed, but as it nears the circumference, the movement of its hand gains in its length. This indicates that time gains in its extent of progress as it gets away from the center of the circle.

Further, this also serves as an explanation to why the velocity of light seems to be fixed. In the first place, it is said that light has a mysterious phenomenon of keeping its velocity at a fixed pace regardless of the distance over which it has progressed. It is a well-known fact that light reflected on a mirror that moves along with a running train where it is, and light reflected on a mirror that is at its standstill on the ground reaches the terminus at the same time, when departed at the same time, despite the difference of their moving distance. In other words, light is said to keep a fixed velocity and when it progresses, it is said that time expands and contracts with the progress of light in order to keep its velocity at a fixed pace. In short, it is conceived that distance over which light has progressed=time×velocity of light, or time=the distance over which light has progressed/velocity of light sets up. However, in this regard, in this subject, it is assumed that time is produced in proportion to the distance over which light has progressed and it relates to energy and substances.

When the statement above is considered as it is checked against the clock-dial, it can be found that the unique nature of light can be seen in the fact that, the nearer it is to the circumference of the clock, the longer is the distance over which the clock-hand progresses, and yet the time passed doesn't make any difference when the lapse of time at the point of the clock-hand is compared to that at the inner side of the dial, or also in the fact that the distance over which the inner side of the clock-hand progresses is shorter compared to the distance over which the hand at its point progresses.

Another example easier to understand is in the assumption that time is something like water. Consider a three-dimensional cone full of water, and assume the wave produced, as an object progresses on its surface or inside, to be the time produced. (cf. [FIG. 2]) Time is something akin to the waves or the currents of water which is produced as an object moves or progresses through, however slightly, though it doesn't flow when an object is at a complete standstill. As waves of water are produced when an object progresses, time is produced in proportion to the movement or progress of the object. And as there is more impact of gravity in the water than on its surface, it's more difficult for the object to progress and what is more, its velocity also becomes lower. In short, while the movement of an object on the surface of water is assumed to be at the velocity of light which is free from gravity, the movement of an object in water is at the velocity less than that of light under the impact of gravity. And as it nears to the apex of the cone, the gravity gains in its impact. That is, the progress of time decreases in its extent. In this connection, the so-called phenomenon of fixed light velocity can be well understood when both the movement of an object on the water surface and that of a clock-hand on the dial are superposed. They both are in the weightless state free from gravity, and as the clock-hand varies in its extent of progress within the dial, light also varies in its extent of progress depending on whether it is in the inner side or the outer side of its circle. And yet, though they both differ in their moving distance, the clock-hand indicates the same passage of time. Considering that they both are under the weightless condition, the cause of this difference could be nothing other than the difference of energy retained. Thus, light progresses over the longer distance in proportion to the amount of energy it retains, namely, the potential energy. In other words, it passes the longer lapse of time in proportion to its potential energy. On the contrary, when the potential energy is at zero, in other words, when it is at the center of the circle, time doesn't progress. As the potential energy decreases, the extent of time that progresses also decreases, and when the potential energy is lost, the time eventually ceases to progress. A rice cooker keeps adding heat energy thereby retains the potential energy of rice and increases time in its extent of progress, that is its duration of time, or a refrigerator deprives heat from foodstuffs thereby decreases their potential energy and reduces time in their extent of progress to keep their freshness. Those phenomena quite make sense when checked against the principle of time. As mentioned above, the unique nature of time was assumed from the models of the clock-dial and three-dimensional cone full of water. Based on this, relation between energy and mass is to be considered in the next stage.

Firstly, when the relation between energy and a substance is formulated, it could be expressed as follows;

(velocity of the substance×1/g)×(time the substance took to progress×1 /g)×mass=energy

E=(v×1/g)×(t×1/g)×m [Math.1]

It is also conceivable that the formula captures each moment of the lapse of time and calculates the total amount of energy that a substance standstill at each moment retains. Though it is said that mass=energy, this formula is composed on the notion that a substance with energy called mass continuously exists in something indicated as a total of time and space, which is velocity×time=distance. And although the terms velocity and distance are being used for the convenience to enhance understanding, this concept could also be applied to the velocity and moving distance of the movement and oscillation of elementary particles. In addition, g=the velocity of the substance/velocity of light, that is, the impact of gravity on the substance. By multiplying 1/g, this formula calculates the energy needed for the substance to actually progress. When the principle of light and time mentioned above is substituted for this formula, the result is as follows;

velocity of the substance×(velocity of light/velocity of the substance)×(distance over which the substance progressed/velocity of the substance)×(velocity of light/velocity of the substance)×mass=energy

E=(v=c/v)×(s/v×c/v)×m [Math.2]

Now, by further putting the formula above in order, the following result could be attained;

(velocity of light/velocity of the substance)²×distance over which the substance progressed×mass=energy

E=(c/v)²×s×m [Math.3]

### That is,

(1/g)²×distance over which the substance progressed×mass=energy.

$$At this point , since , distance over which the substance progressed = velocity of the substance \times time the substance has passed = ( velocity of light \times g ) \times ( time light has passed \times g ) , \\ s = v \times t = ( c \times g ) \times ( T \times g ) \qquad [ Math . 4 ]$$

by substituting the formula above and the principle of light and time shown in [0006][Math.1] for the formula in [Math.3], the result attained is;

energy=mass×velocity of light×time.

E=m×c×T [Math.5]

The procedural calculation is as follows;

$$\begin{matrix}E = m \times s \times {( c / v )}^{2} \\ = m \times ( v \times t ) \times {( c / v )}^{2}\end{matrix} \\ v = c \times g \\ \begin{matrix}t = T \times g \\ = m \times ( c \times g ) \times ( T \times g ) \times {( c / v )}^{2} \\ = m \times c \times T \times {g}^{2} \times {( 1 / g )}^{2} \\ = m \times c \times T\end{matrix} \qquad [ Math . 6 ]$$

Now, time T=time light passes, and this is the time that the substance would have passed under no gravity(g), namely, the time the substance took to progress×1/g. Certainly, as mentioned above, clocks under any gravity show the same lapse of time in relation to the extent of its progress. However, when measured by our clocks on the earth, the extent of progress on the clock of light isn't the same as that under the gravity. Besides, it is important that the formula above isn't the same as the one in the special theory of relativity, E=mc², but that it multiplies velocity of light c by time T. In the formula E=mc² in the special theory of relativity, m stands for a substance with mass m, c for velocity of light and E for rest energy at time 0 which is observed as the substance simply exists. However, in this subject, it is considered that to exist itself means that the substance stays in the lapse of time. Therefore, apart from there being any time at its standstill, as long as there is no such time in this world, it could be said that the element of time is essential on considering energy. When one-dimensional light velocity and time are multiplied by three-dimensional mass, there appears steric time-space with distance. Inside the time-space, it's all at mass m. That is to say, that space turns out to be the track of energy.

Now, there would be further consideration integrating the elements of gradual diminution of mass and velocity into the relational formula of mass and energy in [0006][Math.1]. This is because any substance gradually loses its mass as it loses its energy and eventually stops its movement or progress. Firstly, as for mass, when an abscissa axis is taken as mass and an ordinate axis is taken as time the substance passes, the relation in [FIG. 3] sets up. At this time, initial mass is indicated by m₁, mass at time x as mx, total time the substance passes as t and time at time x as tx. Then, mass at time x, mx, would be expressed as follows;

$$\begin{matrix}{m}_{x} = {m}_{1} - ( {t}_{x} \times {m}_{1} / t ) \\ = {m}_{1} ( 1 - {t}_{x} / t )\end{matrix} \qquad [ Math . 7 ]$$

Next, as for velocity, when an abscissa axis is taken as the velocity and an ordinate axis is taken as the time the substance passes, the relation in [FIG. 4] sets up. At this time, initial velocity is indicated as v₁, velocity at time x as vx, total time the substance passes as t and time at time x as tx. Then, velocity at time x, vx, would be expressed as follows;

$$\begin{matrix}\begin{matrix}{v}^{x} = {v}^{1} - ( {t}_{x} \times {v}_{1} / t ) \\ = {v}_{1} ( 1 - {t}_{x} / t )\end{matrix} & [ Math .8 ]\end{matrix}$$

Now, when reconsidering the relation between mass and energy based on these formulae, it seems more appropriate, this time, to calculate the sum of the product of mass and velocity at each moment of time using Σ as in [Math.9], rather than adopting the formula, (velocity of the substance×1/g)×(time the substance took to progress×1/g)×mass=energy in [0006][Math.1].

$$\begin{matrix}\begin{matrix}E = {\sum }_{K = 1}^{t} {m}_{K} {v}_{K} & ( 1 ≦ K ≦ t ) \\ = {\sum }_{x = 1}^{t} {m}_{x} {v}_{x} & ( 1 ≦ X ≦ t )\end{matrix} & [ Math .9 ]\end{matrix}$$

When mass mx and velocity vx as indicated in [Math.7]and[Math.8] are substituted for the formula above, the result of the calculation is as follows;

$$\begin{matrix}\begin{matrix}E = {\sum }_{K = 1}^{t} {m}_{K} {v}_{K} & ( 1 ≦ K ≦ t ) \\ = {\sum }_{x = 1}^{t} {m}_{x} {v}_{x} & ( 1 ≦ X ≦ t ) \\ = {\sum }_{x = 1}^{t} {m}_{1} & ( 1 - {t}_{x} / t ) \times {v}_{1} ( 1 - {t}_{x} / t ) \\ = {\sum }_{x = 1}^{t} {m}_{1} {v}_{1} & {( 1 - {t}_{x} / t )}^{2} \\ = {\sum }_{K = 1}^{t} {m}_{1} {v}_{1} & {( 1 - {t}_{K} / t )}^{2}\end{matrix} & [ Math .10 ]\end{matrix}$$

Namely, it is found that the formula indicated in [Math.9] can be expressed as follows;

$$\begin{matrix}\begin{matrix}E = {\sum }_{K = 1}^{t} {m}_{K} {v}_{K} & ( 1 ≦ K ≦ t ) \\ = {\sum }_{K = 1}^{t} {m}_{1} {v}_{1} & {( 1 - {t}_{K} / t )}^{2}\end{matrix} & [ Math .11 ]\end{matrix}$$

This formula is the multiplication of initial mass m₁, initial velocity v₁ and (1−tx/t)², namely, the square of the ratio of t−tx ; (time the substance has passed) subtracted from (total time the substance passes) to t. This indicates that the right side of an equation in [Math.9] substituted by [Math.7] and [Math.8], namely, the product-sum of mass and velocity in their value of gradual diminution at each moment of time equals the product of the initial mass and velocity, yet free from diminution, and the factor of time which relates to the remaining time at time x. What it means is that this formula indicates the total sum of the remaining energy retained in the substance at the time of x, namely, the potential energy from time 1 to t.(cf.[FIG. 5]) Further, the reason why the time-factor is squared is because the time-factor is expressed in two-dimension, or as a plane. It is also conceivable that this is the plane which possesses the nature of time. As in [0009], by multiplying the velocity expressed in one-dimensional line, steric space with distance appears. In addition, inside the space, it is all at mass m. In other words, this space also is the track of energy.

However, there's yet no element of the impact of gravity g integrated in the formula attained in [0012] [Math.11]. The formula above in [0011] [Math.9] and this one might as well be called the calculation formulae under the condition of no gravity. But, we need to attain the equation which is applicable to this world. Thus, the calculation is to be done assuming g=velocity of the substance/velocity of light in the following. But, in this calculation, it is provided that the velocity of light also diminishes over its long period of duration until its disappearance. In fact, though light does keep its velocity fixed for quite a long period of time, it would be appropriate to think in this way, as light travels over a long distance and eventually loses energy it retains to finally disappear.

$$\begin{matrix}\begin{matrix}E = {\sum }_{K = 1}^{t} {m}_{K} {v}_{K} \times 1 / g ( 1 ≦ K ≦ t ) \\ = {\sum }_{K = 1}^{t} {m}_{K} {v}_{K} \times {c}_{K} / {v}_{k} \\ = {\sum }_{x = 1}^{t} {m}_{1} ( 1 - {t}_{x} / t ) \times {c}_{1 } ( 1 - {t}_{x} / t ) \\ = {\sum }_{x = 1}^{t} {m}_{1} {c}_{1} {( 1 - {t}_{x} / t )}^{2} \\ = {\sum }_{K = 1}^{t} {m}_{1} {c}_{1} {( 1 - {t}_{K} / t )}^{2}\end{matrix} & [ Math .12 ]\end{matrix}$$

At this point, the impact of gravity on time also needs to be considered. Thereby, the formula above would be;

$$E = {\sum }_{K = 1}^{T} {m}_{1} {c}_{1} {( 1 - {T}_{K} / T )}^{2} T = t \times 1 / g$$

$$( 1 ≦ K ≦ T )$$

Now, on the other hand, in the formula, energy=mass×velocity of light×time in [0008 ] [Math.5], which was attained from the formula, (velocity of the substance×1/g)×(time the substance took to progress×1/g)×mass=energy in [0006] [Math.1], there's no element of gradual diminution integrated. Therefore, the formula is to be calculated by substituting the relational expression in [0010] [Math.7] and [Math.8].

$$\begin{matrix}\begin{matrix}E = m \times c \times T \\ = {\sum }_{K = 1}^{T} {m}_{K} {v}_{K} ( 1 ≦ K ≦ T ) \\ = {\sum }_{X = 1}^{T} {m}_{1} ( 1 - {T}_{x} / T ) \times {c}_{1 } ( 1 - {T}_{x} / t ) ( 1 ≦ X ≦ T ) \\ = {\sum }_{X = 1}^{T} {m}_{1} {c}_{1} {( 1 - {T}_{x} / T )}^{2} \\ = {\sum }_{K = 1}^{T} {m}_{1} {c}_{1} {( 1 - {T}_{K} / T )}^{2}\end{matrix} & [ Math .13 ]\end{matrix}$$

Now, at this point, the significance of the formulae attained in [0013] [Math.12] and in [0014] [Math.13] are to be confirmed. The two formulae attained are both the total sum of a product, which is energy=mass (at its initial value)×velocity of light (at its initial value)×(1−x ; time the substance has passed under no gravity/time the substance passes under no gravity)², and they coincide with each other. It could be said that these formulae express the amount of energy corresponding to the time left behind to the substance, namely, the energy the substance retains at the point of time x, or potential energy. Also, from these formulae, it could be found that a substance gradually loses its potential energy within the passage of time.

In addition, what could be stated after attaining the calculation result is that, as velocity for its potential energy, every substance is endowed with that of light. Certainly, it is only light that can move at the velocity of light. However, we, and the substances surrounding us potentially have the velocity of light, namely, the characteristics of light, for all our energy that we retain, no matter how our mass or period of endurance may be, or though we get the impact from the gravity. In other words, the energy inherent in all substances including us, is no different from the light energy. Also, as for the time indicated in the formulae, the standard of light-time is applied as can be found in the elements of T and Tx. The aspect that can be found in the formulae is as if they are the calculation formulae for the energy of light ‘which accompanies mass’. Based on the statements mentioned above, it could be defined that there's the characteristic of light in substances, or that substances could be ‘light’ which accompany mass.

On the other hand, as the initial velocity of light is fixed, it could be found that the energy a substance retains is proportional to its initial mass m and its period of duration. As period of duration of the substance under no gravity T=t×1/g, namely, time the substance passes×1/g, or T=t×c/v=time the substance passes×velocity of light/velocity of the substance, the smaller the value of velocity of the substance v is, the longer the period of duration T gets. Also, as period of duration of light=distance over which light progresses/velocity of light, that is T=S/c, the longer the distance over which light progresses S is, in other words, the larger the potential energy is, the longer the period of duration of light T gets, and the longer gets the period of duration of the substance t, which is T×g=t. This implies that the potential energy of a substance is proportional to its period of duration.

$$\begin{matrix}\begin{matrix}T = x \times 1 / g & \\ = t \times c / v & \\ T = S / c & S / c = t \times c / v \\ & S = {c}^{2} \times t / v\end{matrix} & [ Math .14 ]\end{matrix}$$

In this regard, as for the distance over which light progresses, namely, the period of duration of light, it is already stated that its potential energy is the only cause conceivable. And the characteristics of light that substances are endowed with also are stated above. Substances possess the velocity of light, though they are under gravity, and as can be seen in the measurement of energy which applies the standard of light-time, they are endowed with the characteristics of light. Based on this, though there's the impact of gravity, the period of duration of a substance also has its potential energy as its cause, in the same way as light. That is, not limited to light that do not have mass, also within the substance with mass under gravity, ‘time’ is produced as it makes movements to consume the potential energy, which is equivalent to, ‘the distance over which the substance progresses’. For instance, if mass=0, the formula of product-sum; energy velocity of light (at its initial value)×(1−time light has passed/time light passes). (cf. [FIG. 6]) This indicates that energy/velocity of light≈time. In short, it is conceivable that time is one form of potential energy which is converted from velocity (namely, velocity of light). In the case of substances, as potential energy gets converted from mass×velocity (namely, velocity of light), the time produced is inversely proportional to mass. In sum, in regard to light, time is produced through its velocity, and to substances, through mass and its velocity (namely, velocity of light). Further, when mass=0 and velocity of light=0, time T which is generated through mass and velocity of light =0 and thereby, energy=0. Taking [FIG. 3], [FIG. 5] and [FIG. 6] into account, it can be acknowledged that this state indicates the timeless condition. Further, it signifies that this condition of timelessness is at the point where energy=0. At this point, time doesn't flow from past to future, but as shown in [FIG. 3], [FIG. 5] and [FIG. 6], when mass and velocity of light are both 0, time lasts forever. Therefore, it was found that timeless condition could be attained by creating the zero state of both mass and velocity of light. Moreover, to make ‘time’ which usually progress from past to future reverse, what has to be done is just to make the value of ‘t’ at under 0. The calculating formulae are shown in [Math.15] and [Math.16] below.

$$\begin{matrix}E = {\sum }_{K = 1}^{T} {m}_{1} {{c}_{1} ( 1 - {T}_{K} / T )}^{2} ( 1 ≦ K ≦ T ) & [ Math . 15 ] \\ E / {\sum }_{K = 1}^{T} {m}_{1} {c}_{1} = {( 1 - {T}_{K} / T )}^{2} & \\ \pm \sqrt{E / {\sum }_{K = 1}^{T} {m}_{1} {c}_{1}} = \pm ( 1 - {T}_{K} / T ) & \\ \pm \sqrt{E / {\sum }_{K = 1}^{T} {m}_{1} {c}_{1}} ∓ 1 = ∓ {T}_{K} / T & \\ T ( \pm \sqrt{E / {\sum }_{K = 1}^{T} {m}_{1} {c}_{1}} ∓ 1 ) = ∓ {T}_{K} ( T > 0 ) & \\ When \pm \sqrt{E / {\sum }_{K = 1}^{T} {m}_{1} {c}_{1}} ∓ 1 < O , ∓ {T}_{K} < O . & \end{matrix}$$

That is, when

\sqrt{E/Σ_{K=1}^{T}m₁c₁}−1<0,−T_{K}<0.

Or when,

$$- \sqrt{E / {\sum }_{K = 1}^{T} {m}_{1} {c}_{1}} + 1 < O , {T}_{K} < O .$$

Whereas, when

\sqrt{E/Σ_{K=1}^{T}m₁c₁}−1<0,−T_{K}>0.

Therefore,

when

\sqrt{E/Σ_{K=1}^{T}m₁c₁}−1>0,−T_{K}<0.

E=Σ_{K=1}^{T}C₁(1−T_{K}/T)(1≤K≤T)

E/Σ_{K=1}^{T}C₁=(1−T_{K}/T)

1−E/Σ_{K=1}^{T}C₁=T_{K}/T

T(1−E/Σ_{K=1}^{T}C₁)=T_{K}(T>0)

When 1−E/Σ_{K=1}^{T}C₁<0, then T_{K}<0 [Math.16]

That is, when

E/Σ_{K=1}^{T}C₁>1, then T_{K}<0.

Or when

E>Σ_{K=1}^{T}C₁, then T_{K}<0.

As above, the methods of calculating potential energy in substances and light, the method of creating timeless condition and the methods of creating reverse time were developed.

### CITATION LIST

### Patent Literature

### Non Patent Literature

[Non Patent Literature 1]

Written by Gary Garber, ‘Velocity and Position Graphs’, [online], the date of update unspecified, [Searched on May 12, 2017],The Internet<URL: http://blogs.bu.edu/ggarber/archive/bua-physics/velocity-and-position-graphs/>

[Non Patent Literature 2]

Written by Mark Headrick, ‘To Find the Relationship Between the Mass and the Timekeeping of the Atmos Clock’, [online] the date of update unspecified, [Searched on May 13, 2017],The Internet<URL: http://www.abbeyclock.com/atmos.html >

[Non Patent Literature 3]

Written by Alexei Gilchrist, ‘Energy in a Damped Harmonic Oscillator’, Updated in 2014, [online], [Searched on May 12, 2017], The Internet<URL: http://www.entropy.energy/scholar/node/damped-harmonic-oscillator-energy>

[Non Patent Literature 4]

Written by Peter Ceperley, ‘Power Loss in Resonators’, Mar. 31, 2011, [online], [Searched on May 12,2017], The Internet<URL: http://resonanceswavesandfields.blogspot.jp/2011/03/power-loss-in-resonators.html>

[Non Patent Literature 5]

Written by Dan Henshaw, ‘Global Heating Saved?’, Dec. 8, 2016, [online], [Searched on May 12, 2017], The Internet<URL: https://carbonlessair.wordpress.com/>

[Non Patent Literature 6]

Written by Keith Gibbs, ‘Mathematical treatment of charging and discharging a capacitor’, 2013, [online], [Searched on May 12, 2017], The Internet<URL: http://www.schoolphysics.co.uk/age16-19/Electricity%20and%20magnetism/Electrostatics/text/Capacitor charge a nd discharge mathematics/index.html>

[Non Patent Literature 7]

Written by UCDavis (LibreTexts), ‘Radioactive Decay’, [online], Updated on Feb. 20, 2017, [Searched on May 13, 2017], The Internet<URL: https://phys.libretexts.org/TextMaps/General Physics Textmaps/Mav%3A University Physics (OpenStax)/Map%3A University Physics III (OpenStax)/10%3A Nuclear Physics/10.3%3A Radioactive Decay>

[Non Patent Literature 8]

Written by Howard S. Matis, ‘Radioactivity’, [online], Updated on Aug. 9, 2000, [Searched on May 13, 2017], The Internet<URL: http://www2.lbl.gov/abc/wallchart/chapters/03/0.html>

[Non Patent Literature 9]

Written by Bruce N. Hoglund, ‘Radiation!’, 1997, [online], [Searched on May 13, 2017],The Internet<URL: http://moltensalt.org.s3-website-us-east-1.amazonaws.com/references/static/home.earthlink.net/bhoglund/radiation Facts.html>

[Non Patent Literature 10]

Written by Jefferson Community and Technical College, ‘Atomic, Nuclear and Modern Physics’, [online], the date of update unspecified, [Searched on May 13, 2017], The Internet<URL: http://legacy.jefferson.kctcs.edu/techcenter/Classes/Physics/AtomicNuclearandModernPhysics/AtomicNuclearandModernPhysics print.html>

[Non Patent Literature 11]

Written by E. Ermis and C. Celiktas, ‘A different Way to Determine the Gamma-ray Linear Attenuation Coefficients of Materials’, 2012, [online], [Searched on May 13, 2017], The Internet<URL: http://article sapub.org/10. 5923.j.instrument.20120104.01.html>

[Non Patent Literature12]

Written by Vasily N. Astratov et al, ‘Photonic nanojets for laser surgery’, Mar. 12, 2010, [online], [Searched on May 13, 2017], The Internet<URL: http://spie.org/newsroom/2578-photonic-nanojets-for-laser-surgery>

[Non Patent Literature 13]

Written by Yuri A. Litvinov et al, ‘Oscillating Electron Capture Decay’, Jan. 14, 2008, [online], [Searched on May 13, 2017], The Internet<URL: http://kamland.lbl.gov/research-projects/ocsillating-electrons-capture-decays-times >

[Non Patent Literature 14]

Written by Society of Photo-Optical Instrumentation Engineers, ‘Measured and predicted light attenuation in dense coastal upslope fog at 650, 850, and 950 nm for free-space optics applications’, Mar. 26, 2008, [online], [Searched on May 13, 2017], The Internet<URL: http://opticalengineering.spiedigitallibrary.org/article.aspx?articleid=108878 4#Introduction>

[Non Patent Literature 15]

Written in Wikipedia (the free encyclopedia), ‘Zero-point energy’, [online], last edited on 28 Apr. 2017, [Searched on May 13, 2017], The Internet: URL: https://en.wikipedia.org/wiki/Zero-point_energy>

### SUMMARY OF INVENTION

The method of calculating potential energy in substances as can be seen in the formula below in [Math.1]. E as is defined here is the potential energy in a substance, T is time the substance passes under no gravity, mi is mass (at its initial value), c₁ is velocity of light (at its initial value), and Tk is time the substance has passed under no gravity.

$$E = {\sum }_{K = 1}^{T} {m}_{1} {c}_{1} {( 1 - {T}_{K} / T )}^{2} ( 1 ≦ K ≦ T ) \qquad [ Math .1 ]$$

Further, the method of calculating potential energy in light as can be seen in the formula below in [Math.2]. E as is defined here is the potential energy in a substance, T is time the light passes under no gravity, m₁ is mass (at its initial value), c₁ is velocity of light (at its initial value), and Tk is time the light has passed under no gravity.

$$E = {\sum }_{K = 1}^{T} {c}_{1} ( 1 - {T}_{K} / T ) ( 1 ≦ K ≦ T ) \qquad [ Math .2 ]$$

In addition, the formula below in [Math.3] sets up as derived from [Math.1] and [Math.2]. E as is defined here is the potential energy in a substance or light, m₁ is mass (at its initial value), c₁ is velocity of light (at its initial value), Tk is time the substance or light has passed under no gravity, and T is time the substance or light passes under no gravity, namely, the existence of time itself.

$$When E = {\sum }_{K = 1}^{T} {m}_{1} {c}_{1} {( 1 - {T}_{K} / T )}^{2} ( 1 ≦ K ≦ T ) and \\ E = {\sum }_{K = 1}^{T} {c}_{1} ( 1 - {T}_{K} / T ) ( 1 ≦ K ≦ T ) , \\ and when {m}_{1} = {c}_{1} = 0 , then E = 0 and T = Tk = ∞ \qquad [ Math .3 ]$$

Moreover, the method of creating reverse time for substances as can be seen in the formula below in [Math.4]. E as is defined here is the potential energy in a substance, T is time the light passes under no gravity, m₁ is mass (at its initial value), c₁ is velocity of light (at its initial value), and Tk is time the light has passed under no gravity.

When

\sqrt{E/Σ_{K=1}^{T}m₁c₁}−1>0(1≤K≤T), T_{K<}0 [Math.16]

And likewise, the method of creating reverse time for light as can be seen in the formula below in [Math.5]. E as is defined here is the potential energy in a substance, T is time the light passes under no gravity, m₁ is mass (at its initial value), c₁ is velocity of light (at its initial value), and Tk is time the light has passed under no gravity.

When

E>Σ_{K=1}^{T}C₁(1≤K≤T), dann T_{K}<0 [Math.5]

### Technical Problem

Provision of the methods of calculating potential energy in substances and light, provision of the method of creating timeless condition and provision of the methods of creating reverse time.

### Advantageous Effects of Invention

Precise calculation of potential energy in substances and light, creation of timeless condition and creation of reverse time.

### BRIEF DESCRIPTION OF DRAWINGS

FIG. 1 The clock-model of time

FIG. 2 The water-model of time

FIG. 3 The graph of gradual diminution of mass

FIG. 4 The graph of gradual diminution of velocity

FIG. 5 The graph of potential energy and time for a substance

FIG. 6 The graph of potential energy and time for light

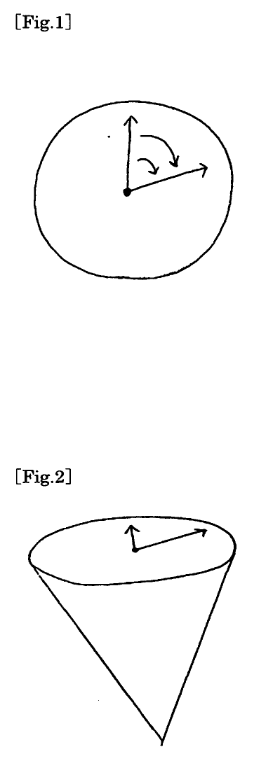

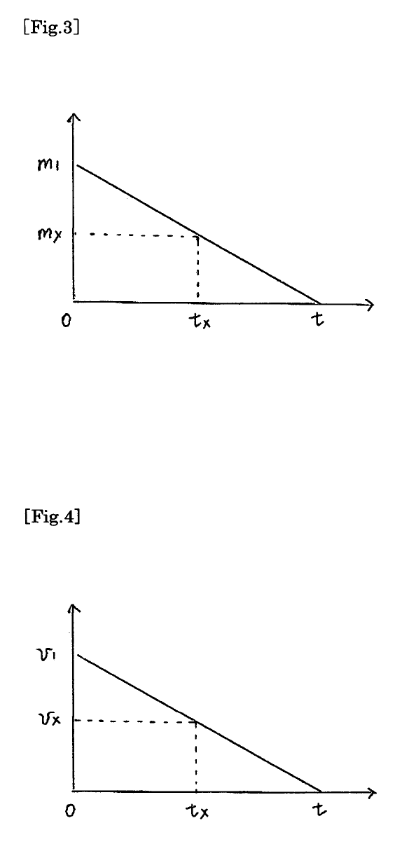

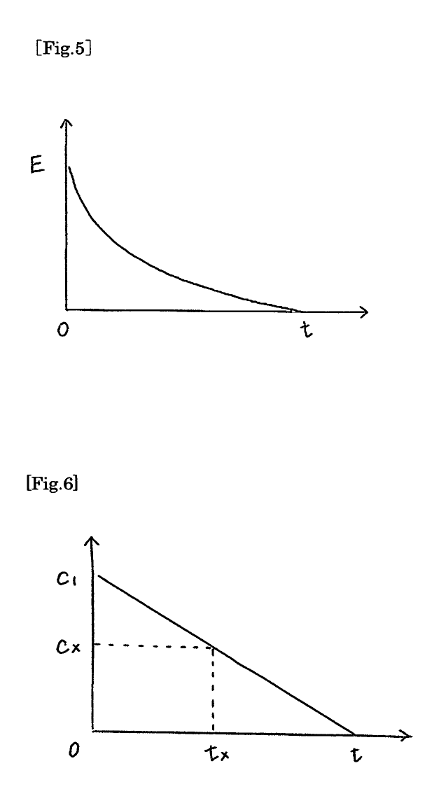

### DESCRIPTION OF EMBODIMENTS

Precise calculation of potential energy in substances and light, creation of timeless condition and creation of reverse time.

### INDUSTRIAL APPLICABILITY

Application to basic and advanced research, accurate measurement of potential energy in substances and light, creation of timeless condition and creation of reverse time.

### REFERENCE SIGNS LIST

1. The method of calculating potential energy in substances as can be seen in the formula below in [Math.1]. E as is defined here is the potential energy in a substance, T is time the substance passes under no gravity, m₁ is mass (at its initial value), c₁ is velocity of light (at its initial value), and Tk is time the substance has passed under no gravity.
$$E = {\sum }_{K = 1}^{T} {m}_{1} {c}_{1} {( 1 - {T}_{K} / T )}^{2} ( 1 ≦ K ≦ T ) \qquad [ Math .1 ]$$

2. The method of calculating potential energy in light as can be seen in the formula below in [Math.2]. E as is defined here is the potential energy in a substance, T is time the light passes under no gravity, m₁ is mass (at its initial value), c₁ is velocity of light (at its initial value), and Tk is time the light has passed under no gravity.
$$E = {\sum }_{K = 1}^{T} {c}_{1} ( 1 - {T}_{K} / T ) ( 1 ≦ K ≦ T ) \qquad [ Math .2 ]$$

3. The method of creating timeless condition as can be seen in the formula below in [Math.3]. E as is defined here is the potential energy in a substance or light, m₁ is mass (at its initial value), c₁ is velocity of light (at its initial value), Tk is time the substance or light has passed under no gravity, and T is time the substance or light passes under no gravity, namely, the existence of time itself.
$$When E = {\sum }_{K = 1}^{T} {m}_{1} {c}_{1} {( 1 - {T}_{K} / T )}^{2} ( 1 ≦ K ≦ T ) and \\ E = {\sum }_{K = 1}^{T} {c}_{1} ( 1 - {T}_{K} / T ) ( 1 ≦ K ≦ T ) , \\ and when {m}_{1} = {c}_{1} = 0 , then E = 0 and T = Tk = ∞ \qquad [ Math .3 ]$$

4. The method of creating reverse time for substances as can be seen in the formula below in [Math.4]. E as is defined here is the potential energy in a substance, T is time the light passes under no gravity, m₁ is mass (at its initial value), c₁ is velocity of light (at its initial value), and Tk is time the light has passed under no gravity.
When
\sqrt{E/Σ_{K=1}^{T}m₁c₁}−1>0(1≤K≤T), T_{K}21 0 [Math.4]

5. The method of creating reverse time for light as can be seen in the formula below in [Math.5]. E as is defined here is the potential energy in a substance, T is time the light passes under no gravity, m₁ is mass (at its initial value), c₁ is velocity of light (at its initial value), and Tk is time the light has passed under no gravity.
When
E>Σ_{K=1}^{T}C₁(1≤K≤T), then T_{K}<0 [Math.5]
